(19) United States
(12) Patent Application Publication
(10) Pub. No.: US 2018/0127978 A1
(43) Pub. Date: May 10, 2018

(54) FIBER-REINFORCED CEMENT SHEET PRODUCT AND A PROCESS FOR PREPARING THE SAME

(71) Applicant: Reliance Industries Limited, Mumbai (IN)

(72) Inventors: Nilesh Shankar Revagade, Kalyan (IN); Thaliyil Veedu Sreekumar, Payangadi (IN); Arun Arora, Mumbai (IN); Chandramouli Gangaram Gajelli, Mumbai (IN); Vikas Kadu Bhangale, Mumbai (IN); Suresh Bhanudas Nikam, Raigad (IN)

(73) Assignee: Reliance Industries Limited, Mumbai (IN)

(21) Appl. No.: 15/574,870

(22) PCT Filed: May 18, 2016
(86) PCT No.: PCT/IB2016/052881

§ 371 Date: Nov. 17, 2017

(30) Foreign Application Priority Data
May 21, 2015 (IN) 1996/MUM/2015

(51) Int. Cl. E04C 2/06; C04B 28/02

(52) U.S. Cl. CPC E04C 2/06; C04B 2111/00612; C04B 28/021

(57) ABSTRACT

The present disclosure relates to a fiber-reinforced cement sheet product. The fiber-reinforced cement sheet product comprises at least one fiber-cement layer and at least one polymeric material layer. The polymeric material layer is chemically bonded to at least one surface of the fiber-cement layer or is sandwiched between two fiber-cement layers, to obtain the fiber-reinforced cement sheet product. The present disclosure further relates to a process for preparing the fiber-reinforced cement sheet product.

### FIELD

The present disclosure relates to the field of civil engineering. Particularly, the present disclosure relates to a fiber-reinforced cement sheet product and a process for preparing the same.

### Definitions

As used in the present disclosure, the following terms are generally intended to have the meaning as set forth below, except to the extent that the context in which they are used indicate otherwise.

Flexural rigidity: The term ‘flexural rigidity’ refers to the force couple required to bend a non-rigid structure to a unit curvature or it can be defined as the resistance offered by a structure while undergoing bending.

Woven fabric: The term ‘woven fabric’ refers to a textile formed by weaving and produced on a loom.

Non-woven fabric: The term ‘non-woven fabric’ refers to a fabric-like material made from long fibers, bonded together by chemical, mechanical, heat or solvent treatment.

Scrim: The term “scrim” or “gauze” refers to a very light textile material made from two set of threads, woven or stick together, which can be used for reinforcing purpose.

Fiber-cement: The term ‘fiber-cement’ refers to concrete containing fibrous material that can take any desired shape.

### BACKGROUND

Fiber-reinforced cement sheet (FRC) is a composition comprising fibrous material, which increases its structural integrity. FRC contains uniformly distributed and randomly oriented short fibers. Conventionally, FRC is prepared using asbestos fibers. However, due to the health hazardous nature of asbestos, alternatives to asbestos fibers such as poly vinyl chloride (PVA), poly acrylonitrile (PAN), polypropylene (PP), polyethylene terephthalate (PET), glass fiber and the like are being tried. Conventional FRC sheets have improved flexural strength; however, these sheets are brittle in nature. Also, the installation of the conventional FRC sheets is laborious and requires heavy support structures. Further, due to poor aesthetic look, the conventional FRC sheets are not well accepted in high end applications.

There is, therefore, felt a need for an alternative that obviates the above mentioned drawbacks.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a fiber-reinforced cement sheet (FRC) product.

Another object of the present disclosure is to provide a process for preparing the fiber-reinforced cement sheet (FRC) product.

Other objects and advantages of the present disclosure will be more apparent from the following description, which is not intended to limit the scope of the present disclosure.

### SUMMARY

The present disclosure relates to a fiber-reinforced cement sheet product. The fiber-reinforced cement sheet product comprises at least one fiber-cement layer and at least one polymeric material layer. The fiber-cement layer is chemically bonded to at least one surface of the fiber-cement layer or is sandwiched between two fiber-cement layers, to obtain the fiber-reinforced cement sheet product.

The thickness of the fiber-reinforced cement sheet product can be in the range of 4 mm to 6 mm.

The fiber-reinforced cement sheet product can be in the form of a sheet and/or a block.

The polymeric material layer can be chemically bonded to the surface of the fiber-cement layer using an adhesive.

The adhesive can be epoxy resin.

The polymeric material layer can be in at least one form selected from the group consisting of a film, a woven fabric, a non-woven fabric, and a scrim.

The thickness of the polymeric material layer can be in the range of 150 microns to 500 microns.

The flexural rigidity of the fiber-reinforced cement sheet product can be in the range of 130 kg/cm² to 190 kg/cm².

The present disclosure also relates to a process for producing the fiber-reinforced cement sheet product.

### BRIEF DESCRIPTION OF THE ACCOMPANYING DRAWING

A fiber-reinforced cement sheet product and a process for preparing the same will now be described with the help of the accompanying drawing, in which:

FIG. 1 depicts the stress-strain curve of a fiber-reinforced cement sheet product and the conventional FRC sheets in accordance with the present disclosure.

### DETAILED DESCRIPTION

Conventional FRC sheets have certain limitations, for instance the:
sheets are brittle in nature;
installation of the sheets is laborious, and it requires heavy support structures; and
sheets cannot be used in high end applications, due to poor aesthetic look.

The present disclosure, therefore, envisages a fiber-reinforced cement sheet product and a process for preparing the fiber-reinforced cement sheet product, so as to obviate the above mentioned drawbacks.

In one aspect of the present disclosure, the fiber-reinforced cement sheet product comprises at least one fiber-cement layer and at least one polymeric material layer. The polymeric material layer is chemically bonded to at least one surface of the fiber-cement layer or is sandwiched between two fiber-cement layers to obtain the fiber-reinforced cement sheet product.

The polymeric material layer can be chemically bonded using an adhesive.

The adhesive can be epoxy resin.

The thickness of the fiber-reinforced concrete product is less, therefore the fiber-reinforced concrete product is light in weight and easy to install.

The thickness of the fiber-reinforced cement sheet product can be in the range of 4 mm to 6 mm.

The fiber-reinforced cement sheet product can be in the form of a sheet and/or a block.

The flexural rigidity of the fiber-reinforced cement sheet product prepared in accordance with the process of the present disclosure can be in the range of 130 kg/cm² to 190 kg/cm².

In accordance with the present disclosure, with the use of the polymeric material layer, the strength of the fiber-reinforced cement sheet product increases as compared to that of the conventional FRC sheets. Further, the same strength can be achieved by reducing the thickness of the fiber-cement layer and applying the polymeric material layer thereon.

The thickness of the polymeric material layer can be in the range of 150 microns to 500 microns.

The polymeric material layer can be in at least one form selected from the group consisting of a film, a woven fabric, a non-woven fabric, and a scrim.

In another aspect of the present disclosure, the fiber-reinforced cement sheet product is prepared by the process steps described herein below.

In the first step, the polymeric material layer is applied to at least one surface of the fiber-cement layer. The polymeric material layer can be chemically bonded to the surface of the fiber-cement layer or it can be sandwiched between two fiber-cement layers.

In the second step, the polymeric material layer is pressed on the surface of the fiber-cement layer with a pressure ranging from 2 kg/cm² to 8 kg/cm² and for a time period ranging from 30 seconds to 120 seconds, to obtain the fiber-reinforced cement sheet product.

After pressing of the polymeric material layer on the surface of the fiber-cement layer, the fiber-reinforced cement sheet product is cured for a time period ranging from 10 days to 15 days.

The curing can be carried out under wet conditions.

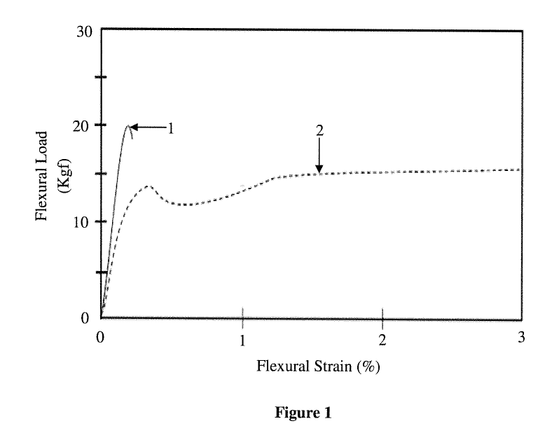

After curing, the fiber-reinforced cement sheet product prepared is tested for flexural rigidity. The flexural rigidity is expressed in terms of “Modulus of rupture based on the area” (MRA). The flexural rigidity can be illustrated by the stress-strain curve as depicted in FIG. 1. From FIG. 1, it is evident that the area under the stress-strain curve increases significantly for the fiber-reinforced concrete product of the present disclosure (represented by curve 2), as compared with the conventional FRC sheets (represented by curve 1). Moreover, the area under the stress-strain curve is directly proportional to the ductility and mechanical strength (toughness) of the product, i.e., if the area under the stress-strain curve is more, then the product will be more ductile or tough. Therefore, as compared to the conventional FRC sheets, the fiber-reinforced cement sheet product of the present disclosure possesses better ductility and mechanical strength (toughness). Due to this, the fiber-reinforced cement sheet product is resistant to catastrophic failure.

The polymeric material layer facilitates in improving the flexural rigidity, and enhancing the aesthetic properties of the fiber-reinforced cement sheet product.

The present disclosure is further described in light of the following experiments which is set forth for illustration purpose only and not to be construed for limiting the scope of the disclosure. The following laboratory scale experiments can be scaled up to industrial/commercial scale.

### EXPERIMENTAL DETAILS

### Experiment 1: Preparing the Fiber-Reinforced Cement Sheet Product Using a Woven Fabric as a Polymeric Material Layer

A woven fabric having an Ends per Inch (EPI) of 72, Picks per Inch (PPI) of 80, and a thickness of 350 microns was used for applying on the surface of a fiber-cement layer comprising 9 wt % asbestos fiber, 54 wt % cement, 35.5 wt % fly-ash, and 1.5 wt % cellulosic pulp. In the first step, the woven fabric was applied on at least one surface of the fiber-cement layer. After applying, the woven fabric was then pressed on the surface of the fiber-cement layer with a pressure of 5 kg/cm² for 60 seconds to obtain the fiber-reinforced cement sheet product in the form of sheets. The thickness of the fiber-reinforced cement sheet product was 6 mm. The sheets so obtained were stacked on each other, in open air, for curing with spraying of water for 14 days.

### Experiment 2: Preparing the Fiber-Reinforced Cement Sheet Product Using a Non-Woven Fabric as a Polymeric Material Layer

A non-woven fabric of 230 Grams per Square Meter (GSM), and 180 microns thickness of was used for applying on the surface of a fiber-cement layer comprising 9 wt % asbestos fiber, 54 wt % cement, 35.5 wt % fly-ash, and 1.5 wt % cellulosic pulp. In the first step, the non-woven fabric was applied on at least one surface of the fiber-cement layer. After applying, the non-woven fabric was then pressed on at least one surface of the fiber-cement layer with a pressure of 5 kg/cm² for 60 seconds to obtain the fiber-reinforced cement sheet product in the form of sheets. The thickness of the fiber-reinforced cement sheet product was 6 mm. The sheets so obtained were stacked on each other, in open air, for curing with spraying of water for 14 days.

It was found that the toughness of the fiber-reinforced cement sheet product prepared in experiment 1 and experiment 2 was higher as compared to the conventional FRC sheets.

### TECHNICAL ADVANCES AND ECONOMICAL SIGNIFICANCE

The present disclosure described herein above has several technical advantages including, but not limited to, the realization of a fiber-reinforced cement sheet product that:
has or exhibits improved flexural rigidity, thereby making the fiber-reinforced concrete product resistant to catastrophic failures; and
is light in weight, aesthetically superior, and easy to install.

The disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description.

Descriptions of well-known components and processing techniques are omitted so as to not unnecessarily obscure the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A fiber-reinforced cement sheet product comprising:
a) at least one fiber-cement layer; and
b) at least one polymeric material layer,
wherein said polymeric material layer is:
chemically bonded to at least one surface of said at least one fiber-cement layer; or
sandwiched between two fiber-cement layers, to obtain said fiber-reinforced cement sheet product.

2. The fiber-reinforced cement sheet product as claimed in claim 1, wherein the thickness of said fiber-reinforced cement sheet product is in the range of 4 mm to 6 mm.

3. The fiber-reinforced cement sheet product as claimed in claim 1, being in the form of a sheet and/or a block.

4. The fiber-reinforced cement sheet product as claimed in claim 1, wherein said polymeric material layer is chemically bonded to said at least one surface of said at least one fiber-cement layer using an adhesive, wherein said adhesive is epoxy resin.

5. The fiber-reinforced cement sheet product as claimed in claim 1, wherein said at least one polymeric material layer is in at least one form selected from the group consisting of a film, a woven fabric, a non-woven fabric, and a scrim.

6. The fiber-reinforced cement sheet product as claimed in claim 1, wherein the thickness of said at least one polymeric material layer is in the range of 150 microns to 500 microns.

7. The fiber-reinforced cement sheet product as claimed in claim 1, wherein the flexural rigidity of said fiber-reinforced cement sheet product is in the range of 130 kg/cm² to 190 kg/cm².

8. A process for preparing said fiber-reinforced cement sheet product as claimed in claim 1, said process comprising the following steps:
a. applying said at least one polymeric material layer to said at least one surface of said at least one fiber-cement layer, wherein said at least one polymeric material layer is chemically bonded to said at least one surface of said at least one fiber-cement layer or sandwiched between two fiber-cement layers; and
b. pressing said at least one polymeric material layer on said at least one surface of said at least one fiber-cement layer with a pressure ranging from 2 kg/cm² to 8 kg/cm² for a time period ranging from 30 seconds to 120 seconds, to obtain said fiber-reinforced cement sheet product.

9. The process as claimed in claim 8, wherein said fiber-reinforced cement sheet product is cured for a time period ranging from 10 days to 15 days.

10. The process as claimed in claim 9, wherein said curing is carried out under wet conditions.
